(19) United States
(12) Patent Application Publication
(10) Pub. No.: US 2012/0137585 A1
(43) Pub. Date: Jun. 7, 2012

(54) Rolling Door Ballooning Monitor Apparatus and Method

(75) Inventors: Michael J. Brown, Bartlett, IL (US); Samir M. Chitnis, Naperville, IL (US)

(73) Assignee: THE CHAMBERLAIN GROUP, INC., Elmhurst, IL (US)

(21) Appl. No.: 12/960,036

(22) Filed: Dec. 3, 2010

(51) Int. Cl. E05F 15/20; E06B 3/00; E05D 15/38; E06B 9/44; G08B 13/08

(52) U.S. Cl. 49/31; 160/10; 49/197; 49/506

(57) ABSTRACT

A movable barrier apparatus, a kit configured to be assembled and mounted adjacent to a barrier opening, and a method of monitoring for ballooning of a movable barrier are described herein. A sensing device is positioned outwardly from a drum configured to receive a movable barrier therearound. A ballooning movable barrier engages or disturbs the sensing device, which, in response to the disturbance, sends a signal, such as a signal to sound an alarm, stop movement of the door, or the like.

### FIELD

This invention relates generally to movable barriers and, more particularly, to rolling door monitoring apparatus and methods.

### BACKGROUND

Different types of movable barriers have been sold over the years. One such type of movable barrier is a rolling door. A rolling door is formed from a number of interlocking hinged slats that provide flexibility to the door and allow the door to be wrapped around a drum in a stored or open configuration. A rolling door may include a hood that encloses the drum and the door when it is in the open configuration. A rolling door is moved from the stored or open configuration to a closed configuration by rotating the drum and unwinding the door, which is lead by tracks to a closed position. Similarly, a rolling door is opened by rotating the drum in the opposite direction to draw the door upward and wrap about the drum.

One of the problems associated with rolling doors is that the door can balloon off of the drum. Ballooning refers to when the rolling door is not wrapped uniformly about the drum, such as when the door bulges off of the drum. Ballooning can occur if the door is forced upward when the drum is stationary or during closing of a rolling door if the door encounters an obstruction and stops moving while the drum continues to rotate. If such ballooning goes unnoticed, further rotation of the drum can damage the door, the drum, the hood, or other components of the movable barrier.

### SUMMARY

A movable barrier apparatus, a kit configured to be assembled and mounted adjacent to a barrier opening, and a method of monitoring for ballooning of a movable barrier are described herein. A sensing device is positioned outwardly from a drum configured to receive a movable barrier therearound. A ballooning movable barrier engages or disturbs the sensing device, which, in response to the disturbance, sends a signal, such as a signal to sound an alarm, stop movement of the door, or the like.

By one approach, a movable barrier apparatus includes a movable barrier that is driven between a closed position and an open position. The apparatus includes a shaft or drum having a circumferential perimeter and a longitudinal axis. The movable barrier is rolled around or unrolled from the drum to transition between the closed and open positions. In one form, the drum is restricted from moving radially along radii extending out and away from the longitudinal axis. An elongate member is positioned adjacent the drum so as to be positioned radially outwardly or spaced from an outer radius of the movable barrier when it is in the open position. At least a portion of the elongate member is disposed generally perpendicular to a line extending radially outwardly from the longitudinal axis of the drum. The elongate member couples to a switch that detects disturbance of the elongate member by the movable barrier when the movable barrier balloons radially away from the drum. A controller in communication with the switch then sends a signal in response to the switch detecting the disturbance of the elongate member. The signal can be sent to at least one of an alarm system, a security system, a movable barrier operator operatively coupled to the drum, or an enunciator, for example.

A kit configured to be assembled and mounted to a substrate proximate to a barrier opening is described herein. The kit includes a drum and a movable barrier that includes a plurality of hinged slats so as to be capable of rolling around the drum to transition between an open and a closed position. A wall mount is provided to couple to the drum and mount to the substrate to hold the drum proximate to the barrier opening. The kit further includes an elongate sensing device configured to be disposed so as to be spaced from an outer radius of the movable barrier when the movable barrier is in the open position. The elongate sensing device monitors positioning of the movable barrier on the drum and sends a signal in response to sensing ballooning of the movable barrier away from the drum.

By one approach, a method of monitoring a movable barrier disposed on a drum is described herein to send a signal in response to ballooning by the movable barrier. This method includes coupling a movable barrier to a rotatable drum having a circumferential perimeter around which the movable barrier is received to transition the movable barrier between an open position, where the movable barrier is wrapped about the drum, and a closed position, where the movable barrier is unwrapped from the drum. The method also includes disposing at least one elongate sensing device spaced radially outward from the movable barrier in the open position so that at least a portion of the elongate member is generally perpendicular to a line extending radially outwardly from the longitudinal axis of the drum. A switch is operably coupled to the elongate member to detect disturbance of the elongate member by ballooning of the movable barrier. In response to sensing ballooning of the movable barrier, a controller in communication with the switch sends a signal. The signal can be received by a movable barrier operator controller to stop or reverse operation of the movable barrier. The signal can also be received by an alarm or security system.

### BRIEF DESCRIPTION OF THE DRAWINGS

The above needs are at least partially met through provision of the rolling door ballooning monitor apparatus and method described in the following detailed description, particularly when studied in conjunction with the drawings, wherein:

FIG. 1 is a perspective view of a portion of a structure defining a barrier opening therein having a rolling door assembly mounted adjacent thereto in a closed position;

FIG. 2 is a perspective view of a rolling door assembly mounted adjacent to a barrier opening having various sensing devices configured to detect ballooning of the rolling door in accordance with various embodiments of the invention;

FIG. 3 is a side cross-sectional schematic view of a rolling door assembly showing a sensing device in a first or undisturbed position in accordance with various embodiments of the invention;

FIG. 4 is a side cross-sectional schematic view of the rolling door assembly of FIG. 3 showing the sensing device in a second or deflected position as a result of ballooning of a rolling door in accordance with various embodiments of the invention;

FIG. 5 is a side cross-sectional schematic view of a rolling door assembly showing a sensing device in a first or undisturbed position in accordance with various embodiments of the invention;

FIG. 6 is a side cross-sectional schematic view of the rolling door assembly of FIG. 5 showing the sensing device in a second or deflected position as a result of ballooning of a rolling door in accordance with various embodiments of the invention;

FIG. 7 is a side cross-sectional schematic view of a rolling door assembly showing a sensing device in a first or undisturbed position in accordance with various embodiments of the invention;

FIG. 8 is a side cross-sectional schematic view of the rolling door assembly of FIG. 7 showing the sensing device in a second or deflected position as a result of ballooning of a rolling door in accordance with various embodiments of the invention;

FIG. 9 is a side cross-sectional schematic view of a rolling door assembly showing an elongate sensing device in a first or undisturbed position in accordance with various embodiments of the invention;

FIG. 10 is a side cross-sectional schematic view of the rolling door assembly of FIG. 9 showing the elongate sensing device in a second or deflected position as a result of ballooning of a rolling door in accordance with various embodiments of the invention; and

FIG. 11 is a side cross-sectional schematic view of a rolling door assembly showing an elongate sensing device in a first or undisturbed position in accordance with various embodiments of the invention; and

FIG. 12 is a side cross-sectional schematic view of the rolling door assembly of FIG. 11 showing the elongate sensing device in a second or deflected position as a result of ballooning of a rolling door in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

A sensing device monitors the radial positioning of a rolling door coupled to a drum and at least partially wrapped therearound. The sensing device is positioned so as to detect when the rolling door radially balloons off of or away from the drum, the detection of which causes a signal to be sent to a controller. The controller can then cause an action to be performed, including, for example, sounding an alarm, stopping movement of the movable barrier, energizing a light, sending an alert, or the like.

During normal operation, the rolling door winds around and unwinds from the drum to selectively cover a barrier opening. The sensing device is positioned so as to not interfere with this normal operation, but detect when the rolling door deviates from normal functionality and balloons radially away from the drum. The sensing device includes an elongate member that projects to a position adjacent the drum, such that the elongate member is disturbed by a ballooning rolling door.

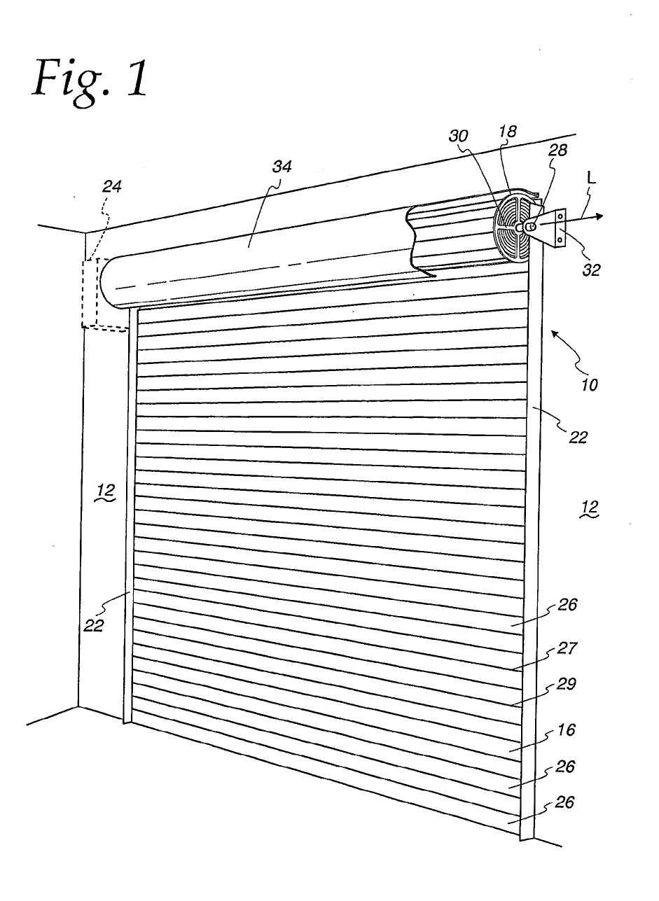

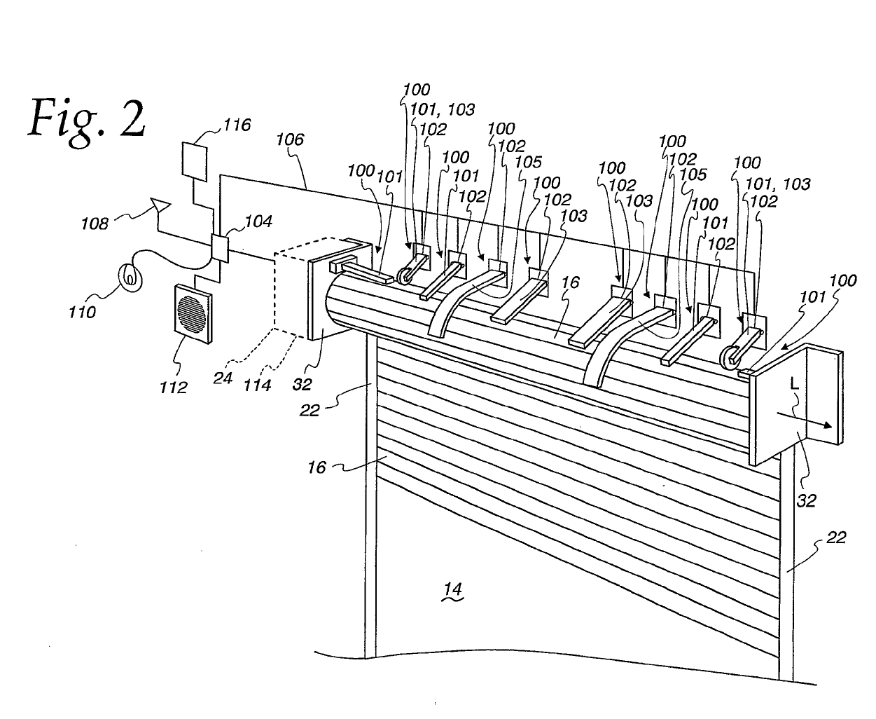

Referring now to the drawings and especially FIG. 1, an example rolling door assembly 10 is illustrated. The rolling door assembly 10 is configured to be mounted to a wall or substrate 12 adjacent to an opening 14 to provide selective access therethrough. The rolling door assembly 10 includes, at least in part, a rolling door 16 coupled to a drum 18 at a top portion 20 of the rolling door 16 and guide rails or tracks 22 to direct movement of the rolling door 16. The drum 18 generally cylindrical and includes a circumferential perimeter and a central longitudinal axis L around which it rotates to direct movement of the rolling door 16. So positioned, the rolling door 16 is movable between a closed position unrolled from the drum 18 and covering the opening 14 (FIG. 1) and a stored or raised position rolled around the drum 18 and partially or completely exposing the opening 14 (FIG. 2). Movement of the rolling door 16 can be driven by, for example, a movable barrier operator or a manually-operated crank 24. Such an operator can be controlled by typical devices, including a push button control unit, which can include an electronic controller and a keypad, or a remote control device that is configured to wirelessly send command signals to a receiver in the operator. So configured, the drum 18 is rotated and the rolling door 16 is wrapped around or unwrapped from the drum 18 and guided by the tracks 22 to raise or lower the rolling door 16 with respect to the opening 14.

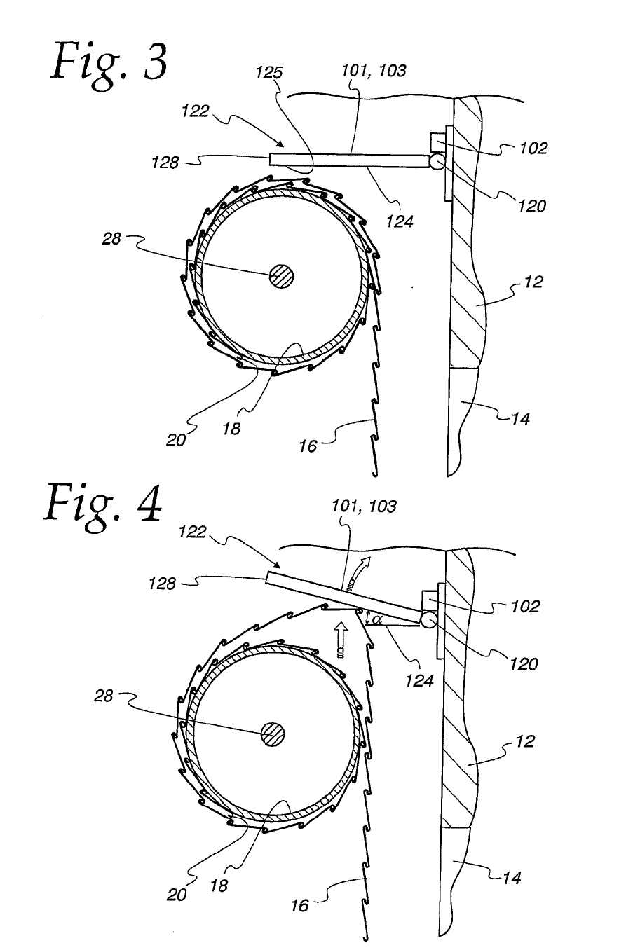

More particularly, in one form, the rolling door 16 is comprised of rectangular slats or panels 26. Each slat 26 rotatably couples to adjacent slats along top and bottom edge portions 27, 29 thereof to form the rolling door 16. As discussed above, the rolling door 16 couples to the drum 18 along its top edge portion 20 (FIG. 3). By one approach, the drum 18 is hollow and connected to a shaft 28 by a coupling member 30. In one form, the shaft 28 is a live shaft that, as known in the art, rotates along with the drum 18, which can utilize a bearing internal to an attached operator or crank. In another form, the shaft 28 is a dead shaft that, as known in the art, remains stationary during movement of drum 18 and uses an external bearing between the shaft 28 and the drum 18. The shaft 28 couples to mounting brackets 32 that attach to the wall 12 by conventional methods. The mounting brackets 32 restrict the drum 18 from moving radially along radii extending out and away from the longitudinal axis L. Similarly, the guide rails 22 mount to the wall 12 adjacent sides of the opening 14 in a conventional manner. The rolling door assembly 10 may further include a hood or cover 34 that at least partially surrounds and preferably encloses the drum 18 therein. The hood 34 conceals the drum 18 and the portions of the rolling door 16 wrapped around the drum 18 and provides protection for the rolling door assembly 10.

The rolling door assembly 10 further includes at least one sensing device 100, 122, 140 having an elongate member 101, 103, 105, 142 configured to monitor positioning of the rolling door 16 on the drum 18 and detect ballooning of the rolling door 16. The sensing device 100, 122, 140 then sends a signal in response to the detection of a ballooning rolling door. As discussed above, ballooning refers to when the rolling door 16 is not wrapped uniformly about the drum 18, such as when the door bulges radially off of the drum 18. Ballooning can occur in a number of situations, including, for example, the rolling door 16 becoming stuck or striking an obstacle while being driven to a closed position and the drum 18 continues to rotate, a person or other object forcing the door upward without complementary rotation of the drum, an object becoming stuck between the layers of rolling door being wound around the drum when the door is being opened, or the like. The elongate member 101, 103, 105, 142 is positioned adjacent the circumferential perimeter of the drum 18 such that the elongate member 101, 103, 105, 142 is positioned radially outwardly of an outer radius of the rolling door 16 in the stored position wrapped around the drum 18. The elongate member 101, 103, 105, 142 can be in contact with the rolling door 16 or spaced therefrom.

Referring now to FIG. 2, there are shown example shapes and configurations that the sensing device 100 can take; however, a person of ordinary skill in the art will recognize that other shapes, sizes, and configurations can also be utilized to achieve the desired ballooning monitoring and detection. The rolling door assembly 10 can include one or more sensing devices 100 to monitor ballooning at various points along the drum 18 as desired and/or can include a variety of widths to monitor some, most, or all of the width of the drum 18. The sensing device 100 is mounted proximate to the drum 18 and includes the elongate member 101, 103, 105 that projects to a position adjacent the drum 18. The elongate member 101, 103, 105 is operably coupled to or incorporates a switch 102 that is set to actuate upon detection of ballooning by the sensing device 100 when the elongate member 101, 103, 105 is disturbed by the ballooning rolling door 16. The switch 102 is in communication with a controller 104, such that actuation of the switch 102 sends the detection signal to the controller 104 through a wired connection or wirelessly through a receiver or transceiver 108. The switch 102, shown in a schematic view in the figures, can take any suitable form, including, for example, a trip switch, a toggle switch, a knife switch, a pushbutton switch, a rotary switch, a momentary switch, a reed switch, a pull switch, a snap-action switch, an optical sensor, a capacitance sensor, an inductance sensor, a circuit breaker, a strain gauge, a proximity sensor, or equivalents thereof. Due to the various structures of suitable switches, the switch 102 can be positioned above the elongate member 101, 103, 105 as shown, below the elongate member, be incorporated within the elongate member or the operator 24, or otherwise be associated with the elongate member so that deflection thereof causes actuation of the switch 102.

The controller 104 can then be operably connected, such as by wires 106 or a wireless communication device 108, such as a transmitter, or transceiver, to any number of devices to send a signal so that actions are performed in response to the ballooning detection by the switch 102, as illustrated in FIG. 2. In another approach, the controller 104 may be built into the movable barrier operator 24. For example, the controller 104 can be configured to send a command signal to perform one or more of the following in response to receiving a ballooning detection signal from the switch 102: energize a light 110, activate a siren or alarm 112, apply a brake 114 to stop movement of the rolling door 16, which brake 114 can be a separate device or be incorporated within the operator or crank 24, power a motor to reverse movement of the rolling door 16, notify an annunciator 116 to announce the ballooning, notify a separate security system for the structure, or the like. One or more of these devices can be utilized to notify a person in the vicinity of the rolling door assembly 10 of the ballooning, such as through activation of a light, including a strobe light, one or more LEDs, colored lights, or a combination thereof; sounding an alarm or siren; broadcasting a previously recorded message; or the like. Alternatively, or in combination with the local notification, the controller can cause remote notification, including, for example, call or message, including short media message, multimedia message, email, or the like, of a contact stored or associated with the system, notify an in-house, remote, or third-party security system, or the like.

The sensing device or devices 100 are positioned proximate to the drum 18 to monitor the positioning of the rolling door 16 wrapped around the drum 18 or feeding onto the drum 18. The sensing device 100 can be mounted using a bracket or mount 107 at a variety of locations proximate to the drum 18, including for example, to the wall 12, to one of the brackets 32, to an interior 118 of the hood 34, to the shaft 28, to the movable barrier operator or crank 24 or to other suitable locations. One or more sensing devices 100 can be mounted to monitor a single rolling door. For example, a single sensing device may be disposed at one end or the middle of the drum 18. In another approach, the sensing devices 100 can be disposed at both ends of the drum 18 in case ballooning occurs irregularly across the drum 18.

By one approach, the elongate member 101, 103, 105 is substantially rigid (aluminum, hardened plastic, or the like) and is pivotably mounted to the bracket 107 using a hinge 102 to one of the areas discussed above so that displacement of the rolling door 16 radially away from the drum 18 displaces the elongate member 101, 103, 105 an angle. Displacement of the elongate member 101, 103, 105 causes the elongate member 101, 103, 105 to pivot resulting in a displacement angle α. A sufficient value for the displacement angle α, which can be about 1 degree or more depending on the mounting and elongate member configuration, actuates the switch 102, which sends the signal to the controller 104. The sensing device 100 can utilize a separate hinge 120 to rotate and actuate the switch 102, or the switch 102 can include rotation capabilities.

The sensing device 100 having one example elongate member 101, as illustrated in FIGS. 3 and 4, is mounted to the wall 12 by the hinge 120 and projects outwardly therefrom to or over the drum 18, so that at its closest point 125 the elongate member 101 is spaced from the drum 18 a distance equal to an outer diameter of the rolling door 16 when it is in its maximum open position and wound around the drum 18 or within an a ballooning detection zone, which ranges from the maximum outer diameter to about 5 inches (about 12.7 centimeters) spaced radially from the drum 18. The point 125 can also provide a segment of the sensing device 100 that is generally perpendicular to a radius of the drum 18 extending within a plane through the longitudinal axis L and the door 16 wrapped therearound. In this configuration, the sensing device 100 is held at a predetermined angle, such as generally horizontal as shown in FIGS. 2 and 3 or angled relative to the wall 12. The hinge 120 can be configured with a stop surface that constrains downward rotation of the elongate member 101 below the predetermined angle. Alternatively, the stop surface can be provided by separate hardware or the like. With this positioning, the sensing device 100 is held substantially stationary, and the switch 102 is configured to actuate and send the signal to the controller 104 upon detection of a sufficient value for the displacement angle α, which in this configuration is about 1 degree or more depending on the given configuration.

In one form, the elongate member 101 includes a generally planar segment 124 that is positioned to be impacted by the ballooning rolling door 16. The cross-section of the elongate member 101 can take any suitable shape, including, for example, generally rectangular, circular; or other regular or irregular polygons. Alternatively, by another approach as shown in FIGS. 2-4, the elongate member 101 has a greater width, such as a rod or bar. Yet another approach provides a wider elongate member 103 having a paddle shape, or the like. If desired, the width of the elongate member can be extended up to the width of the drum 18 to monitor some or all of the width of the drum 18. Alternatively or in addition, two or more sensing devices can be utilized at different locations along the drum 18 to monitor desired positions.

So configured according to these approaches of FIG. 2, the sensing device 100 is positioned adjacent the drum 18 to allow the sensing device 100 to detect when the rolling door 16 balloons radially off of the drum 18 for any of the reasons discussed above.

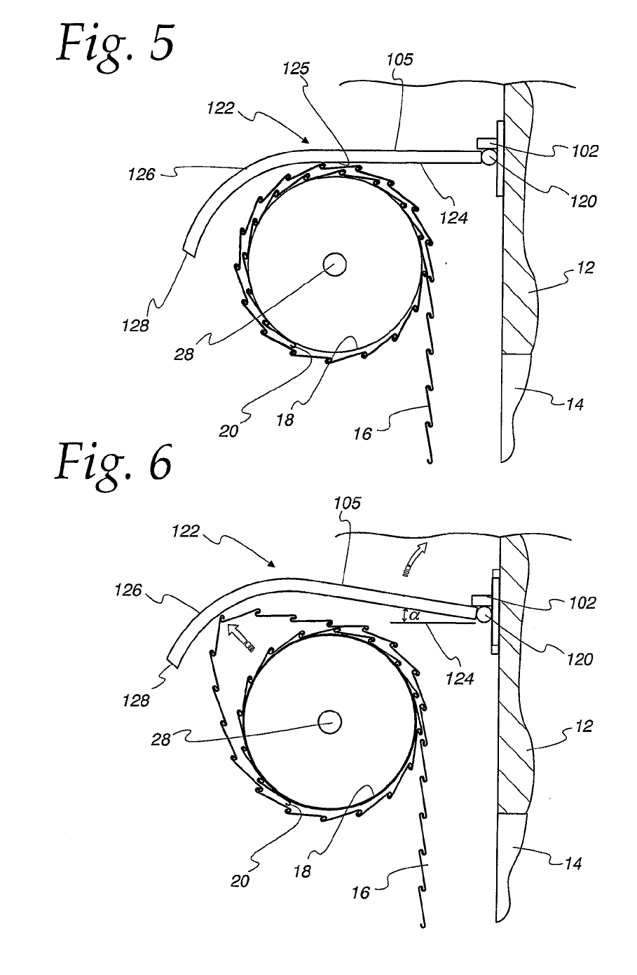

In another form and with reference to FIGS. 5 and 6, the elongate portion 105 includes an arcuate portion 126 that projects from the generally planar segment 124 and extends at least partially around the drum 18. In one approach, the arcuate portion 126 is generally complementary to the perimeter of the drum 18 and the rolling door 16 wrapped around the drum 18. In this form, the arcuate portion 126 is spaced from the drum 18 and rolling door 16 a distance equal to or slightly greater than an outer diameter of the rolling door 16 when it is in its maximum open position and wound around the drum 18 similar to the generally planar segment discussed above. As illustrated in FIG. 2, the arcuate portion 126 extends for about a quarter of the circumference of the drum 18, but it could extend longer or shorter, as desired. The arcuate portion 126 provides greater monitoring coverage of the circumference of the drum 18 than just the generally planar segment 124. As shown in FIGS. 5-6, a distal end 127 of the arcuate portion 126 can be spaced a greater distance from the drum 18, so as to not interfere with the operation of the rolling door 16 as it winds and unwinds from the drum 18.

As also shown in the approach of FIGS. 5-6, a sensing device 122 is not vertically constrained and has free rotation about the hinge 120. As such, the sensing device 122 continually abuts the drum 18 and/or the rolling door 16 wrapped around the drum 18. When the rolling door assembly is at rest, the sensing device 122 rests upon the rolling door 16, or drum 18 if the rolling door 16 is completely unwound from the drum 18. If the door 16 is forced upward and radially displaced away from the drum 18, the door 16 also displaces the elongate member 101, 103, 105 resting on the door 16 or drum 18. When the rolling door 16 is being opened or closed, the drum 18 rotates underneath the sensing device 122 and the rolling door 16 is wound onto or unwound from the drum 18. Free rotation allows the sensing device 122 to remain in contact with the door 16 or drum 18 during the opening or closing. With this configuration, during normal operation of the rolling door assembly 10 the sensing device 122 will transition between a low level position where the door 16 is closed and unwound from the drum 18 to its minimum wrap point and a high level position where the door 16 is open and fully wound around the drum 18. The sensing device 122 is configured, therefore, to not send the signal within this range. Once this range is established, however, the sensing device 122 and switch 102 can be calibrated to send a signal if it is displaced to a higher level than during normal operation, which would indicate that the door 16 is ballooning off of the drum 18. Thus, the elongate member 101, 103, 105, in combination with the switch 102, sends a signal to the controller 104 when the displacement angle α deviates from the normal operation range, such as by about 1 degree or more. In this form, a distal end of the sensing device 122 can be positioned past the drum 18 or spaced from the drum 18 so as to not be caught in or by the rolling door 16 while it is wound and unwound from the drum 18. One or more of the sensing devices 122 can be mounted along the drum 18 and otherwise configured as described above with respect to the sensing device 100.

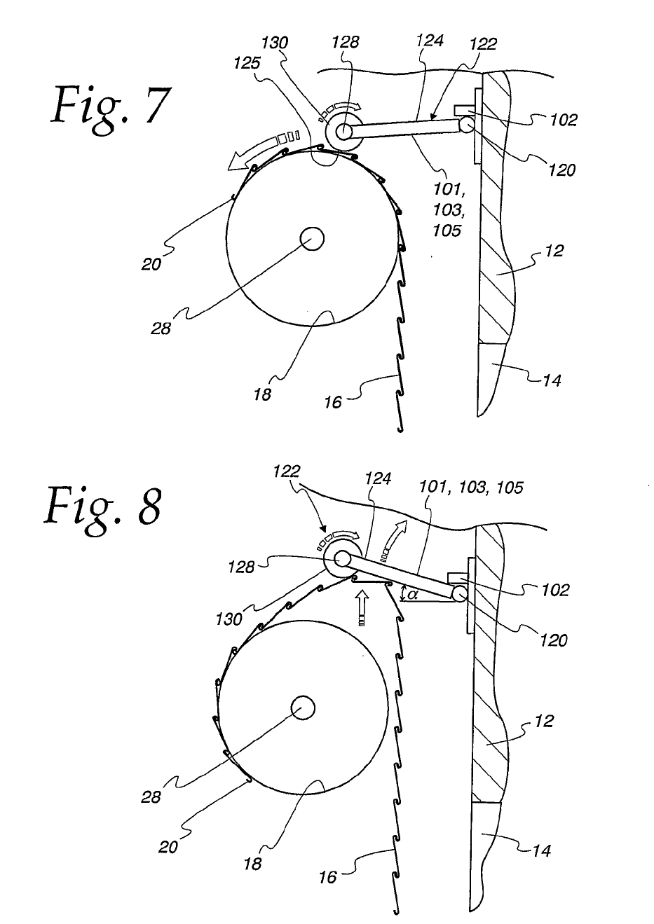

In the approach of FIGS. 7-8, a wheel, caster, or the like 130 couples to the distal end 128 of the elongate member 101, 103, 105. This configuration utilizes the wheel 130 to more easily allow the rolling door 16 to slide underneath the sensing device 122 when opening and closing as compared to the sensing device 122 that lies directly on the door 16 or drum 18. The wheel 130 can be utilized with sensing devices mounted in any orientation with respect to the drum longitudinal axisL as long as the wheel 130 is generally oriented to rotate in a plane generally perpendicular to the drum longitudinal axis L.

With regard to the example sensing devices that continuously contact the drum 18 and/or rolling door 16, such as those illustrated in FIGS. 5-8, a program may be provided that monitors the positioning and operation of the sensing device 100, and specifically the positioning and operation of switch 102, such that upon detection of ballooning by the rolling door 16, the program causes a signal to be sent to the controller 104. The controller 104 can then perform actions as discussed above. The program can be operated in conjunction with the controller 104 on a separate computing device, including a suitable processor or controller, memory, or the like, or can operate on such hardware in the movable barrier operator 24, as desired. By one approach, the program monitors the rate of deflection of the elongate member 101, 103, 105 via signals sent by the switch 102. During normal operation, including winding the rolling door 16 around the drum 18, unwinding the rolling door 16 from the drum, and holding the rolling door 16 at a desired height, the rate of deflection of the elongate member 101, 103, 105 is either zero or a generally constant number, such as about ⅓ inch (about 0.85 centimeter) per second, with a total diameter change of the drum 18 with the rolling door 16 wrapped therearound being about 14 inches (about 35.5 centimeters) to about 20 inches (about 50.8 centimeters). It will be understood, however, that structural and use details specific to any installation may vary these numbers. Accordingly, if the elongate member 101, 103, 105 experiences an unexpected increase, i.e., the rate of deflection increases above a given threshold, the rolling door 16 is likely ballooning off of the drum 18, and the program notifies the controller 104 of the ballooning. Additionally, or by another approach, the program monitors the elongate member 101, 103, 105 such that when the elongate member 101, 103, 105 is deflected over a set maximum value for the displacement angle α, such as about 1 degree or more, as measured radially away from the drum 18, the program sends a signal to the controller 104.

By one approach, the program implements this functionality by receiving signals indicating a current deflection of the elongate member 101, 103, 105 and storing a value that corresponds to the current deflection with a time corresponding to the current deflection. The program then at a later time receives later signals indicating a later deflection and compares the later deflection to the previously stored current deflection based on the time corresponding to the previously stored current deflection and the later time. If the later deflection is larger than the previously stored current deflection by a predetermined amount for a given time period between receiving the previously stored current deflection and the later deflection, for example, greater than one inch (about 2.54 centimeters) over one second, the program will send a signal to the controller 104 indicating detection of ballooning. It will be understood that the above algorithm to be performed by the program can be prepared in any number of computer programming languages by one skilled in the art. It will be also understood that the timing of receiving and comparing signals can be adapted for a given configuration. Moreover, deflection measurements could be averaged over time to reduce errors.

As discussed above, the rolling door assembly 10 can include the hood 34. In such a configuration, the sensing device 100, 122 can be mounted to the wall 12 or to the hood 34 to project perpendicular to or at an angle to the drum longitudinal axis L. If mounted to or within the hood 34, the sensing device 122 and/or hood 34 is sized to allow sufficient rotation of the drum 18 and door 16 and to detect ballooning and actuate the switch 102.

As illustrated in FIG. 2, the sensing device 100 can also be mounted so as to extend along the drum longitudinal axis L. This configuration can utilize the various elongate members 101, 103 as discussed above. As shown, the device 100 is spaced from the drum 18 and the rolling door 16 as described with regard to the first embodiment above, such as a distance equal to or greater than the radius of the drum and rolling door when the door is in its maximum open position. With this positioning, however, ballooning of the rolling door 16 can displace the sensing device 122 both vertically and/or horizontally. Accordingly, the hinge 122 is configured to accommodate lateral, as well as vertical, movement, such as a ball joint or the like. So configured, the switch 102, having any of the configurations discussed above, sends a signal to the controller 104 when the sensing device 122 is displaced vertically and/or horizontally a sufficient distance. Similarly, the sensing device 122 of this form can alternatively be mounted to the hood 34 or coupled to the shaft 28 with a bracket or the like to project generally parallel to the longitudinal axis L of the drum 18.

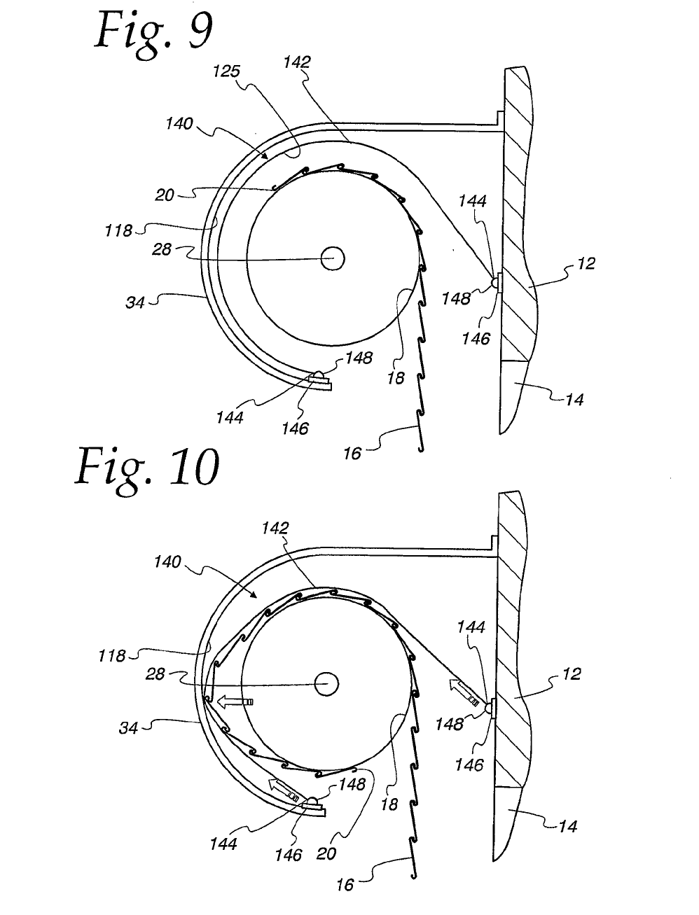

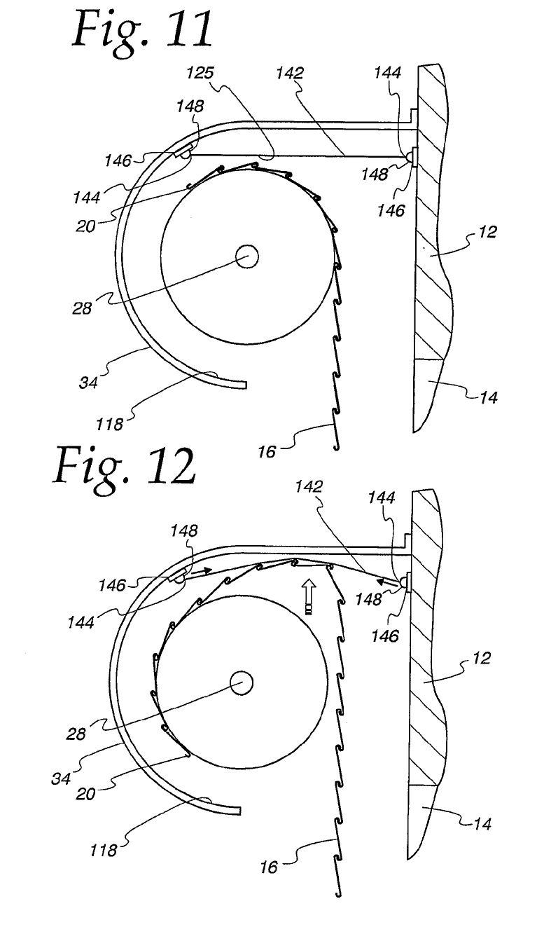

Another example sensing device 140 is illustrated in FIGS. 9-10. In this form, the rolling door assembly 10 includes the hood 34, and the sensing device 140 is mounted within the hood 34. The sensing device 140 of this form includes an elongate member 142 connected at least at opposite ends 144 thereof to the wall 12 or hood 34, as desired or required by the assembly 10. The elongate member 142 can also be connected at various points along its length or can break down into discreet segments extending between connections as desired or required by the assembly 10 and the structure or material of the elongate member 142. By one approach, the elongate member 142 is thin, shaped or formed generally rigid material, such as metal or plastic, curved to be generally complementary to the curvature of the drum 18. Alternatively, the rolling door assembly 10 could include a downwardly and/or outwardly depending bracket to provide a lower mounting surface for the sensing device 140.

Specifically, in this example, the elongate member 142 couples to mounts 146, one or more of which include a switch 148, either integrally or connected thereto, that sends a signal in response to a sufficient tensile force, such as that created by being pulled on by the elongate member 142 which can range from about 1 lb. (about 0.45 kg) to about 25 lbs. (about 11.34 kg). The switch 148 can take any suitable form, including, for example, a trip switch, a mechanical switch, an optical sensor, a capacitance sensor, an inductance sensor, a strain gauge, a proximity sensor, or the like. As illustrated, one of the mounts 146 is mounted to the wall 12, and the elongate member 142 extends outwardly therefrom at least partially around the perimeter of the drum 18 to connect to the other mount 146. The elongate member 142 is sized and spaced outwardly from the drum 18, so that it does not interfere with or signal ballooning of the rolling door 16 during normal operation of the rolling door assembly 10 and is positioned radially outwardly of the rolling door 16 in the open position.

In the illustrated example, the elongate member 142 is at least slightly rigid, but sufficiently malleable or arcuately shaped to be generally complementary with the perimeter of the drum 18 and rolling door 16 wrapped around the drum 18. One example approach includes using a low gage wire as the elongate member 142. Additionally, the elongate member 142 includes a tensile strength sufficient to withstand an impact by a ballooning rolling door. Combined with the rigidity, deflection of the elongate member 142 actuates the switch 148.

In the illustrated form, the elongate member 142 extends around a majority of the perimeter of the drum 18. In this form, the rigidity of the elongate member 142 can also allow it to stay spaced from the rolling door 16 as the door 16 is wound and unwound from the drum 18 during operation of the rolling door assembly 10; however, the elongate member 142 could be sized or configured to at least partially contact the rolling door 16 such that the rolling door 16 slides past the elongate member 142 when winding and unwinding from the drum 18. In this approach, the elongate member 142 is spaced from the drum 18 a distance equal to or greater than the radius of the drum 18 and rolling door 16 when the rolling door 16 is in the maximum open position.

By another approach, the elongate member 142 can be stretched into a taut configuration between two mounts in a position such that its closest point 125 is spaced from the drum 18 a distance equal to or greater than the radius of the rolling door 16 and drum 18 in the maximum open configuration. This approach monitors the rolling door 16 similarly to the sensing device 100 described above, but actuates the switch 148 with a tensile force created by deflection caused by ballooning.

So configured, the sensing device 140 is positioned to monitor the rolling door 16 for ballooning. When the rolling door 16 radially deflects off of the drum 18, the door 16 abuts and applies a tensile force on the elongate member 142, which pulls on the switch 148 to send a signal to the controller 104.

By a further approach, the elongate member 142 can be a light beam and the mounts 146 can be sensors configured to monitor the light beam therebetween. For example, a single beam 142 can be directed generally around a portion of the circumferential perimeter of the drum 18 using a plurality of mirrors or multiple beams can be monitored by multiple sensors, as desired. In this approach, when the rolling door 16 balloons away from the drum 18, the door 16 will break the beam 142 emitting between the sensors, which causes an optical switch 102 to send the detection signal to the controller 104, as discussed above. The sensors can be mounted so that the beam projects generally perpendicular to the longitudinal axis L of the drum, can be mounted at an angled thereto, or generally along the longitudinal axis L by mounting the sensors to the brackets 32 or the like.

The sensing device 100, 120, 140 can be packaged as a part of a kit, packaged together to be offered for sale, that is configured to be assembled and mounted to the substrate 12 adjacent to the movable barrier opening 14. The kit includes the sensing device 100, 140 which includes the elongate member 101, 103, 105, 142 for one or more desired configurations and arrangements, the switch 102, and the hinge 122 for pivotable elongate members.

By one approach, the kit is a retrofit for installation into installed rolling door assemblies or rolling door assemblies lacking a ballooning sensing device. As such, the kit can further include the controller 104 and connection mechanisms, which can include the wires 106 and/or transmitter and/or receiver 108. Additionally, the kit can include desired secondary devices that operate in response to a signal sent from the controller 104 as a result of ballooning by the rolling door 16, including, for example, the above described light 110, speaker 112, annunciator 116, transceiver 108, and/or movable barrier operator/crank/brake 24. The kit can be configured to independently monitor the rolling door 16 for ballooning or could be configured to connect to a movable barrier operator, hand operated crank, or brake to stop movement of the rolling door 16.

By another approach, the kit can form a part of a prepackaged rolling door assembly configured to be assembled and installed over a barrier opening 14. The kit of this form can include the rolling door 16, the drum 18, the guide rails 22, the brackets 32, the controller 104, the hood 34, and the shaft 28. The kit can include the hand crank or movable barrier operator 24 as desired. The controller 104, which is configured to receive the ballooning signal from the switch 102, can be a controller in the movable barrier operator 24 or can be a separate device as desired.

Those skilled in the art will recognize that a wide variety of modifications, alternations, and combinations can be made with respect to the above described embodiments with departing from the scope of the invention. For instance, although several configurations, shapes, and sizes for a ballooning sensing device have been described, other suitable configurations, shapes, and sizes could also be utilized to achieve the desired monitoring. Such modifications, alternations, and combinations are to be viewed as being within the ambit of the inventive concept.

What is claimed is:

1. A movable barrier apparatus comprising:
a drum having a longitudinal axis and a circumferential perimeter;
a movable barrier having a top portion thereof coupled to the drum, the movable barrier configured to be moved between an unrolled position covering a barrier opening and a stored position rolled around the drum;
an elongate member positioned adjacent to the circumferential perimeter of the drum so that the elongate member is positioned radially outwardly of the movable barrier in the stored position;
a switch configured to detect disturbance of the elongate member by ballooning of the movable barrier; and
a controller in communication with the switch, the controller configured to send a signal in response to the switch detecting the disturbance.

2. The movable barrier apparatus of claim 1 wherein the elongate member extends at least partially along the longitudinal axis of the drum.

3. The movable barrier apparatus of claim 1 wherein at least a portion of the elongate member is generally perpendicular to a plane through the longitudinal axis of the drum.

4. The movable barrier apparatus of claim 1 wherein the elongate member is selected from a group consisting of: a wire, a rod, a paddle, a wheel, or a beam.

5. The movable barrier apparatus of claim 1 further comprising a device configured to receive the signal, the device selected from a group consisting of an alarm system, a security system, a movable barrier operator, or an annunciator.

6. The movable barrier apparatus of claim 1 further comprising a wireless communication device in communication with the controller, the wireless communication device configured to transmit the signal.

7. The movable barrier operator apparatus of claim 1 wherein the elongate sensing device comprises at least one of a mechanical switch, a trip switch, an optical sensor, a capacitance sensor, an inductance sensor, a strain gauge, or a proximity sensor.

8. A movable barrier operator apparatus comprising:
a shaft coupled to a drum having a rotational axis;
a movable barrier coupled to the drum and configured to wrap around and unwrap from the drum to be moved between open and closed positions with respect to a barrier opening; and
an elongate sensing device disposed spaced from an outer radius of the movable barrier in the open position wrapped around the drum, the elongate sensing device configured to monitor positioning of the movable barrier on the drum and send a signal in response to sensing ballooning of the movable barrier radially away from the drum.

9. The movable barrier operator apparatus of claim 8 wherein the elongate sensing device comprises at least one of an elongate beam or elongate trip switch extending along at least a portion of the drum.

10. The movable barrier operator apparatus of claim 9 wherein the elongate trip switch comprises an elongate wire positioned radially outwardly around at least a portion of a perimeter of the drum so that the elongate wire is positioned radially outwardly of the movable barrier in the open position.

11. The movable barrier operator apparatus of claim 8 wherein the elongate sensing device is configured to send the signal to at least one of an alarm system, a security system, a movable barrier operator, or an annunciator.

12. The movable barrier apparatus of claim 8 wherein the elongate trip switch is selected from a group consisting of: a wire, a rod, a paddle, or a wheel.

13. The movable barrier operator apparatus of claim 8 wherein the elongate sensing device comprises at least one of a mechanical switch, a trip switch, an optical sensor, a capacitance sensor, an inductance sensor, a strain gauge, or a proximity sensor.

14. The movable barrier operator apparatus of claim 8 further comprising a controller operably coupled to the elongate sensing device, the controller configured to stop movement of the movable barrier in response to receiving the signal.

15. The movable barrier operator apparatus of claim 14 wherein the controller is further configured to reverse direction of the movable barrier in response to receiving the signal.

16. A kit configured to be assembled and mounted to a substrate proximate to a barrier opening, the kit comprising:
a movable barrier comprising a plurality of hinged slats;
a rotatable drum configured to receive the movable barrier therearound to move the movable barrier between a closed position covering the barrier opening and an open position rolled around the drum;
a wall mount configured to couple to the drum and mount to the substrate; and
an elongate sensing device configured to be disposed spaced from a circumferential perimeter of the drum to monitor positioning of the movable barrier on the drum and send a signal in response to sensing ballooning of the movable barrier away from the drum, the elongate sensing device disposed radially outwardly of the movable barrier in the open position.

17. A ballooning sensing device kit configured to be mounted proximate to a rolling door movable barrier, the kit comprising:
a mount configured to be secured proximate to a drum of a rolling door movable barrier;
an elongate member configured to couple to the mount and be disposed in a position spaced from a perimeter of the drum;
a switch configured to operably couple to the elongate member and send a detection signal in response to the elongate member being deflected by a ballooning rolling door; and
a controller configured to send a command signal in response to reception of the detection signal from the switch.

18. The ballooning sensing device kit of claim 16 further comprising a hinge configured to pivotably couple the elongate member to the mount.

19. A movable barrier apparatus comprising:
a drum having a circumferential perimeter and a central longitudinal axis about which the drum rotates, the drum being held from moving radially along radii extending out and away from the longitudinal axis;
a movable barrier configured to be moved between a closed position and a stored position rolled around the circumferential perimeter of the drum and the central longitudinal axis of the drum;
at least one elongate member disposed radially outwardly of the movable barrier in the stored position around the perimeter of the drum, at least a portion of the elongate member being generally perpendicular to a line extending radially outwardly from the longitudinal axis of the drum;
a switch configured to detect disturbance of the elongate member by the movable barrier moving radially away from the circumferential perimeter of the drum; and
a controller in communication with the switch, the controller configured to send a signal in response to detecting the disturbance.

20. The movable barrier apparatus of claim 19 wherein the at least one elongate member comprises an arcuate portion that is generally complementary to curvature of the perimeter of the drum and is configured to extend at least partially therealong.

21. A method of monitoring a radial position of a rolling door disposed on a drum with an elongate member disposed radially outwardly of the drum, the method comprising:
the elongate member deflecting in response to an impact by the rolling door ballooning radially away from the drum;
detecting the deflection of the elongate member with a switch;
the switch sending a detection signal to a controller; and
the controller sending a command signal in response to reception of the detection signal.

22. The method of claim 21 further comprising a device performing an action in response to reception of the command signal.

23. The method of claim 22 wherein the device performing an action comprises at least one of energize a light, activate an alarm, stop movement of the rolling door, reverse movement of the rolling door, notify an annunciator, notify a security system, call a predetermined contact, or message a predetermined contact.

24. The method of claim 21 wherein the switch sending the detection signal to the controller comprises the switch sending the detection signal wirelessly to the controller.

25. A method of installing a ballooning sensing device to monitor a radial position of a rolling door disposed on a drum of a rolling door assembly, the method comprising:
securing a mount proximate to the drum;
coupling an elongate member to the mount;
positioning the elongate member adjacent to the drum so that at least a portion of the elongate member is within a ballooning detection zone;
operably coupling the elongate member to a switch configured to send a detection signal in response to the elongated member
operably coupling the switch to a controller configured to send a command signal in response to reception of the detection signal.

26. The method of claim 25 wherein coupling the elongate member to the mount comprises pivotably coupling the elongate member to the mount with a hinge.

27. The method of claim 25 wherein securing the mount proximate to the drum comprises securing the mount to a surface from a group consisting of a substrate, a hood; a rolling door mounting bracket, or a shaft.

28. The method of claim 25 wherein positioning the elongate member adjacent to the drum comprises positioning the elongate member generally parallel to the a central longitudinal axis of the drum.

29. The method of claim 25 wherein positioning the elongate member adjacent to the drum comprises positioning the elongate member generally perpendicular to a central longitudinal axis of the drum.

30. The method of claim 25 further comprising configuring the switch to send the detection signal upon detection of disturbance of the elongate member by a ballooning rolling door.

31. The method of claim 25 further comprising:
mounting the drum to a substrate adjacent to a barrier opening such that the drum is rotatable about a central longitudinal axis and otherwise restricted from radial movement along radii extending out and away from the central longitudinal axis;
coupling a top portion of the rolling door to a circumferential perimeter of the drum, the rolling door configured to be moved between a closed position covering the barrier opening and a stored position rolled around the circumferential perimeter of the drum.
